(19) United States
(12) Patent Application Publication
(10) Pub. No.: US 2008/0232670 A1
(43) Pub. Date: Sep. 25, 2008

(54) METHOD FOR CALCULATING A BAD-LOT CONTINUITY AND A METHOD FOR FINDING A DEFECTIVE MACHINE USING THE SAME

(75) Inventors: Jie Hau Li, Taipei County (TW); Ping Shan Chen, Changhua County (TW)

Correspondence Address: WPAT, PC;INTELLECTUAL PROPERTY ATTORNEYS, 2030 MAIN STREET, SUITE 1300, IRVINE, CA, 92614, US

(73) Assignee: PROMOS TECHNOLOGIES INC., Hsinchu (TW)

(21) Appl. No.: 11/747,140

(22) Filed: May 10, 2007

(30) Foreign Application Priority Data
Mar. 23, 2007 (TW) 096110030

(51) Int. Cl. G06K 9/00

(52) U.S. Cl. 382/141

(57) ABSTRACT

A method for finding a defective machine comprises the steps of selecting a searching period in which a plurality of wafer lots including good wafer lots and bad wafer lots passes through machines, acquiring a lot-passing information related to the passing sequence of the wafer lots through the machines, calculating a bad-lot continuity by taking the lot-passing information into account, and determining a defective machine by taking the bad-lot continuity into account. The bad-lot continuity is calculated by the steps of determining an impact period based on the aggregation degree of the bad wafer lots, calculating a bad-lot distribution probability in the impact period, and calculating the bad-lot continuity by taking the bad-lot distribution probability into account.

### BACKGROUND OF THE INVENTION

(A) Field of the Invention

The present invention relates to a method for calculating a bad-lot continuity and a method for finding a defective machine, and more particularly, to a method for calculating a bad-lot continuity and a method for finding a defective machine capable of avoiding the occurrence of misjudgments.

(B) Description of the Related Art

In order to produce a particular circuitry on a semiconductor wafer, the wafer has to pass through several processing steps such as depositing, lithographic, etching, ion-implanting and thermal-treating processes. Each of these processes must be performed perfectly on the wafer in order to produce the desired functional circuitry and each of the processes is monitored to detect errors as early as possible. To ensure that the circuitry is fully functional, in-line testers conduct electrical and/or physical tests on the wafers after certain key processes, and the test data is sent to various diagnostic tools to determine whether any errors occurred in that particular process. If a defect is detected, an operator traces the processing history of the wafer and determines which process erred and generated the defect.

The conventional commonality analysis is used in determining the defective machine/process. Because a semiconductor factory typically has several production lines running simultaneously, an operator may locate the defective machine/process by finding a common machine/process that all of the defective wafers have passed through. Suppose wafers having high defective rates all went through a particular ion-implantation process, and wafers that did not go through that particular ion-implantation process had very few defects, then it is likely that the ion-implantation process is the source of the defects.

However, some processes may have multiple machines and some machines may be used in more than one process such that the conventional commonality analysis may show a single non-defective machine itself having an extremely high percentage of defective wafers since all the defective wafers went through the machine. The conventional commonality analysis only takes the relative numbers of the good wafer lots and the bad wafer lots into account, and can misjudge non-defective machines as defective. In addition, the conventional commonality analysis cannot provide information about the impact period of the defective process/machine.

### SUMMARY OF THE INVENTION

One aspect of the present invention provides a method for calculating a bad-lot continuity and a method for finding a defective machine, which uses the continuity analysis technique to avoid the occurrence of misjudgments.

A method for finding a defective machine according to this aspect of the present invention comprises the steps of selecting a searching period in which a plurality of wafer lots including good wafer lots and bad wafer lots passes through machines, acquiring lot-passing information related to the passing sequence of the wafer lots through the machines, calculating a bad-lot continuity by taking the lot-passing information into account, and determining a defective machine by taking the bad-lot continuity into account. The bad-lot continuity is calculated by the steps of determining an impact period based on the aggregation degree of the bad wafer lots, calculating a bad-lot distribution probability in the impact period, and calculating the bad-lot continuity by taking the bad-lot distribution probability into account.

The conventional commonality analysis is likely to misjudge non-defective machines as defective since it only takes the relative numbers of the good wafer lots and the bad wafer lots into account, and cannot provide information about the impact period of the defective process/machine. In contrast, the present application can provide information about the impact period of the defective machine, and take the bad-lot continuity of each machine in the impact period into account to determine the defective machine. Since the bad-lot continuity of each machine relates to the continuous degree of the bad wafer lots passing through each machine, the present application can avoid the occurrence of misjudgments originating from the conventional commonality analysis only taking the relative numbers of good wafer lots and bad wafer lots into account.

### BRIEF DESCRIPTION OF THE DRAWINGS

The objectives and advantages of the present invention will become apparent upon reading the following description and upon reference to the accompanying drawings in which:

FIG. 1 shows a method for determining the impact period of each machine according to the present invention.

### DETAILED DESCRIPTION OF THE INVENTION

The method for finding a defective machine according to the present invention first selects a searching period in which a plurality of wafer lots including good wafer lots and bad wafer lots passes through several machines EQP1, EQP2 and EQP3, and acquires lot-passing information related to the passing sequence of the wafer lots through these machines EQP1, EQP2 and EQP3, as the lot table shown in the following table 1. For example, the searching period has 20 wafer lots with total number (n) of good wafer lots being 9 and total number (m) of bad wafer lots being 11.

TABLE 1

| | | number | number |
|---|---|---|---|
| | | of bad | of good |
| machine | passing sequence | wafer lots | wafer lots |
| EQP1 | XOXOX | b₁ (3) | g₁ (2) |
| EQP2 | XOXXOXOOOXXOXOO | b₂ (7) | g₂ (8) |
| EQP3 | OOXXXXXXOXXXXOOOX | b₃ (11) | g₃ (6) |

O: good wafer lots (n = 9);
X: bad wafer lots (m = 11)

Subsequently, the bad-lot ratio of each machine is calculated from the total number (m) of bad wafer lots and the number of bad wafer lots of each machine, and the good-lot ratio of each machine is calculated from the total number (n) of good wafer lots and the number of good wafer lots of each machine. For example, the bad-lot ratio (EQP1_B) and the good-lot ratio (EQP1_G) of the machine (EQP1) can be calculated according to the following equation:

$$EQP1\_B = \frac{{b}_{1}}{m} \times 100 \%$$

$$EQP1\_G = \frac{{g}_{1}}{n} \times 100 \%$$

Similarly, the bad-lot ratio and the good-lot ratio of the machines (EQP2 and EQP3) can be calculated as well according to the above equation. Consequently, these machines can be ranked in view of the bad-lot ratio, as shown in the following table 2, in which the machine EQP3 has a highest bad-lot ratio:

TABLE 2

| | bad-lot ratio | good-lot ratio |
|---|---|---|
| machine | (EQP_B) | (EQP_G) |
| EQP3 | 100 | 66.7 |
| EQP2 | 63.6 | 88.9 |
| EQP1 | 27.3 | 22.2 |

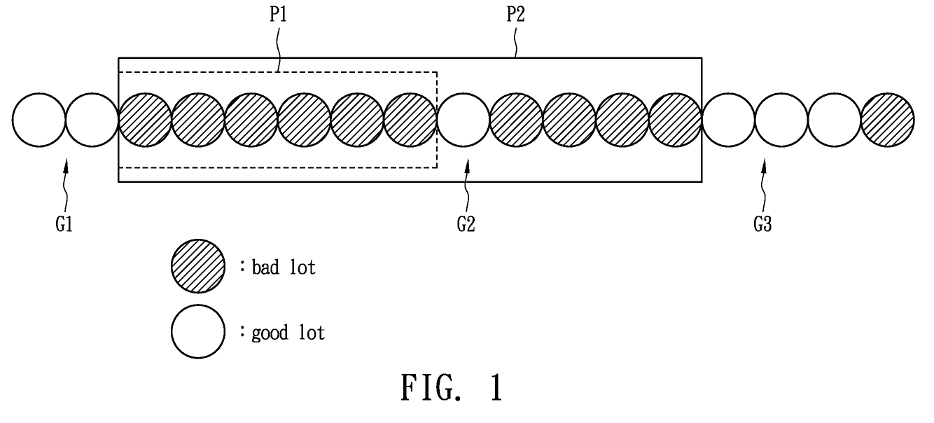

FIG. 1 shows a method for determining the impact period of each machine in view of the aggregation degree of the bad wafer lots according to the present invention. First, the present method searches for a provisional period (P1 with dashed line) having a maximum of bad wafer lots sandwiched between two good-lot groups (G1, G2), and checks if the lot numbers of the two good-lot groups (G1, G2) are higher than a predetermined value. If the checking result is false, the provisional period is extended until the lot numbers of the two good-lot groups (G1, G2) are higher than the predetermined value. Conversely, if the checking result is true, the provisional period is set to be the impact period. For example, the predetermined value is set as 2 and the lot number (1) of the good-lot group (G1) is smaller than 2, the provisional period is extended from P1 to P2 until the lot number (3) of the good-lot group (G3) is larger than 2 and the lot number (2) of the good-lot group (G1) is equal to 2 such that the provisional period (P2) is determined to be the impact period of the machine (EQP3). Similarly, the impact period of the machines (EQP1 and EQP2) can be determined by using the method described above, as shown in the following table 3 with dashed lines. In particular, the machine EQP2 has two impact periods.

TABLE 3

| machine | impact period |
|---|---|
| EQP1 | 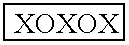 |
| EQP2 | 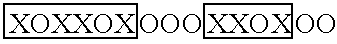 |
| EQP3 | 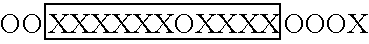 |

□: impact period; O: good wafer lots; X: bad wafer lots

Subsequently, the bad-lot continuity of each machine in the impact period is calculated. First, the present method calculates the good-lot group number and the bad-lot group number of the machines in the impact period. For example, the machine EQP1 has 5 wafer lots (2 good wafer lots and 3 bad wafer lots) in the impact period, the 5 wafer lots are separated from each other, and the group number is 5; the machine EQP 3 has 11 wafer lots in the impact period, 10 bad wafer lots separated by one good wafer lot, and the group number is 3.

The probability density function and the distribution function consisting of the group number of machines are calculated. For example, to calculate the probability density function of the machine EQP1 with group number of 5, the combination number (C₁) of good-lot group number (2) and the bad-lot group number (3) can be calculated in advance as following:

$${C}_{1} = \frac{5 !}{3 ! 2 !} = 10$$

The combination number and every distribution status of the bad wafer lots in the impact period are taken into account to calculate the probability of the distribution status as shown in the following table 4.

$$P ( {R}_{{b}_{1} , {g}_{1}} = r ) = \frac{Count}{{C}_{1}}$$

R represents the random variable.

TABLE 4

| | | group | | probability |
|---|---|---|---|---|
| EQP1 | distribution status | number | count | density |
| 3X2O | XXXOO, OOXXX | 2 | 2 | P(R_{3,2} = 2) = 2/ |
| | | | | 10 = 0.2 |
| | OXXXO, XXOOX, XOOXX, | 3 | 4 | 0.4 |
| | XOOXX | | | |
| | OXXOX, XOXXO, OXOXX | 4 | 3 | 0.3 |
| | OXOXO | 5 | 1 | 0.1 |

Subsequently, the distribution function of the machine EQP1 can be calculated from the group number according to the following equation, as shown in the following table 5:

TABLE 5
$P ( {R}_{{b}_{1} , {g}_{1}} \leq r ) = {\sum }_{k = 1}^{r} P ( {R}_{{b}_{1} , {g}_{1}} = k )$

| EQP1 | group number | distribution function |
|---|---|---|
| 3X2O | ≦2 | 0.2 |
| | ≦3 | 0.2 + 0.4 = 0.6 |
| | ≦4 | 0.2 + 0.3 + 0.4 = 0.9 |
| | ≦5 | 0.2 + 0.3 + 0.4 + 0.1 = 1 |

After the distribution functions of the machines are calculated, the bad-lot continuity of each machine in the impact period can be calculated according to the following equation:

EQP_{—}C=(1−P(R_{b}_{₁}_{,g}_{₁}≦r₁))×100

For example, the bad-lot continuity of the machine EQP1 is calculated to be between 0 and 1.

In particular, if g₁>10 and b₁>10, the distribution of the random variable (R) is substantially a normal distribution with mean (μ) and standard deviation (σ) as following:

$$μ = 1 + \frac{2 {b}_{1} {g}_{1}}{{b}_{1} + {g}_{1}}$$

$$σ = \sqrt{\frac{2 {b}_{1} {g}_{1} ( 2 {b}_{1} {g}_{1} - {b}_{1} - {g}_{1} )}{{( {b}_{1} + {g}_{1} )}^{2} ( {b}_{1} + {g}_{1} - 1 )}}$$

As a result, the bad-lot continuity of the machine EQP1 in the impact period can be calculated alternatively by using the following equation:

EQP1_{—}C=(1−P(|Z|≧|z*|))×100

Z represents the standard normal distribution, and z*=(r₁−μ)/σ.

Similarly, the bad-lot continuity of the machines EQP2 and EQP3 in the impact period can be calculated as well by using the above method, as shown in the following table 6:

TABLE 6

| | | group | bad-lot |
|---|---|---|---|
| machine | impact period | number | continuity |
| EQP1 | XOXOX | 5 | 0 |
| EQP2 | XOXXOXOOOXXOXOO | 5, 3 | 92.1, 84.1 |
| EQP3 | OOXXXXXXOXXXXOOOX | 3 | 97 |

Finally, the good-lot ratio, the bad-lot ratio and the bad-lot continuity in the impact period of these machines are taken into account to determine a defective machine. For example, the defective machine can be determined based on the following equation:

EQP_SCORE=a×EQP_{—}B+b×EQP_{—}C−c×EQP_{—}G

EQP_SCORE represents an aggregative score, EQP_B represents the bad-lot ratio, EQP_G represents the good-lot ratio, EQP_C represents the bad-lot continuity, and a, b, c are weighting factors with a>b≧c. In particular, the values of the weighting factors can be changed by the user according his experience.

The aggregative scores of these machines is calculated based on the above equation and shown in the following table 7:

TABLE 7

| | bad-lot | good-lot | bad-lot | aggregative |
|---|---|---|---|---|
| | ratio | ratio | continuity | score |
| machine | (EQP_B) | (EQP_G) | (EQP_C) | (EQP_SCORE) |
| EQP3 | 100 | 66.7 | 97.0 | 66.1 |
| EQP2 | 63.6 | 88.9 | 92.1 | 38.8 |
| EQP1 | 27.3 | 22.1 | 84.1 | 28.7 |

a = 0.6;
b = 0.2;
c = 0.2

In view of the table 7, the machine EQP3 has the highest aggregative score, and is most probable to be the defective machine. The conventional commonality analysis is likely to misjudge the non-defective machine as defective since it only takes the relative numbers of the good wafer lots and the bad wafer lots into account, and cannot provide information about the impact period of the defective process/machine. In contrast, the present application can provide information about the impact period of the defective machine, and take the bad-lot continuity of each machine in the impact period into account to determine the defective machine. Since the bad-lot continuity of each machine relates to the continuous degree of the bad wafer lots passing through each machine, the present application can avoid the occurrence of misjudgments originating from the conventional commonality analysis only taking the relative numbers of the good wafer lots and the bad wafer lots into account.

The above-described embodiments of the present invention are intended to be illustrative only. Numerous alternative embodiments may be devised by those skilled in the art without departing from the scope of the following claims.

What is claimed is:

1. A method for calculating a bad-lot continuity, comprising the steps of:
acquiring a lot-passing information related to the passing sequence of wafer lots through machines, wherein the wafer lots include good wafer lots and bad wafer lots;
determining an impact period based on an aggregation degree of the bad wafer lots;
calculating a bad-lot distribution probability in the impact period; and
calculating the bad-lot continuity by taking the bad-lot distribution probability into account.

2. The method for calculating a bad-lot continuity of claim 1, wherein the step of determining an impact period based on an aggregation degree of the bad wafer lots comprises the steps of:
searching a provisional period having a maximum of bad wafer lots sandwiched between two good-lot groups;
checking if the lot numbers of the two good-lot groups are higher than a predetermined value;
extending the provisional period until the lot numbers of the two good-lot groups are higher than the predetermined value if the checking result is false; and
setting the provisional period to be the impact period if the checking result is true.

3. The method for calculating a bad-lot continuity of claim 1, wherein the step of calculating a bad-lot distribution probability in the impact period comprises the steps of:
calculating a good-lot group number and a bad-lot group number in the impact period;
calculating a combination number of the good-lot group number and the bad-lot group number; and
calculating the bad-lot distribution probability by taking the combination number and a distribution status of the bad wafer lots into account.

4. The method for calculating a bad-lot continuity of claim 3, further comprising a step of calculating a probability of the distribution status of the bad wafer lots based on a distribution function.

5. The method for calculating a bad-lot continuity of claim 4, wherein the distribution function is a normal distribution function.

6. The method for calculating a bad-lot continuity of claim 4, wherein the distribution function is generated from the distribution status of the bad wafer lots and the distribution status of the good wafer lots.

7. A method for finding a defective machine, comprising the steps of:
selecting a searching period in which a plurality of wafer lots passes through machines, wherein the wafer lots include good wafer lots and bad wafer lots;
acquiring a lot-passing information related to the passing sequence of the wafer lots through the machines;
calculating a bad-lot continuity by taking the lot-passing information into account; and
determining a defective machine by taking the bad-lot continuity into account.

8. The method for finding a defective machine of claim 7, wherein the step of calculating a bad-lot continuity by taking the lot-passing information into account comprising:
determining an impact period based on an aggregation degree of the bad wafer lots;
calculating a bad-lot distribution probability in the impact period; and
calculating the bad-lot continuity by taking the bad-lot distribution probability into account.

9. The method for finding a defective machine of claim 8, wherein the step of determining an impact period based on an aggregation degree of the bad wafer lots comprises:
searching a provisional period having a maximum of bad wafer lots sandwiched between two good-lot groups;
checking if the lot numbers of the two good-lot groups are higher than a predetermined value;
extending the provisional period until the lot numbers of the two good-lot groups are higher than the predetermined value if the checking result is false; and
setting the provisional period to be the impact period if the checking result is true.

10. The method for finding a defective machine of claim 8, wherein the step of calculating a bad-lot distribution probability in the impact period comprises:
calculating a good-lot group number and a bad-lot group number in the impact period;
calculating a combination number of the good-lot group number and the bad-lot group number; and
calculating the bad-lot distribution probability by taking the combination number and a distribution status of the bad wafer lots into account.

11. The method for finding a defective machine of claim 10, further comprising a step of calculating a probability of the distribution status of the bad wafer lots based on a distribution function.

12. The method for finding a defective machine of claim 11, wherein the distribution function is a normal distribution function.

13. The method for finding a defective machine of claim 11, wherein the distribution function is generated from the distribution status of the bad wafer lots and the distribution status of the good wafer lots.

14. The method for finding a defective machine of claim 7, further comprising the steps of:
calculating a good-lot ratio and a bad-lot ratio; and
determining the defective machine by taking the bad-lot continuity, the good-lot ratio and the bad-lot ratio into account.

15. The method for finding a defective machine of claim 14, wherein the good-lot ratio is calculated from the total number of good wafer lots and the number of good wafer lots of each machine.

16. The method for finding a defective machine of claim 14, wherein the bad-lot ratio is calculated from the total number of bad wafer lots and the number of bad wafer lot of each machine.

17. The method for finding a defective machine of claim 14, wherein the defective machine is determined based on the following equation:
EQP_SCORE=a×EQP_{—}B+b×EQP_{—}C−c×EQP_{—}G; and
EQP_SCORE represents an aggregative score, EQP_B represents the bad-lot ratio, EQP_G represents the good-lot ratio, EQP_C represents the bad-lot continuity, and a, b, c are weighting factors with a>b≧c.
